(19) United States
(12) Patent Application Publication
(10) Pub. No.: US 2011/0302070 A1
(43) Pub. Date: Dec. 8, 2011

(54) Systems and Methods for Netting of Transactions

(75) Inventor: Matthew Durkin, Richmond (GB)

(73) Assignee: BARCLAYS BANK PLC, London (GB)

(21) Appl. No.: 12/960,216

(22) Filed: Dec. 3, 2010

Related U.S. Application Data
(60) Provisional application No. 61/266,710, filed on Dec. 4, 2009.

(51) Int. Cl. G06Q 40/00

(52) U.S. Cl. 705/37

(57) ABSTRACT

An aspect comprises a computer readable memory that stores information regarding a first derivatives transaction between a first entity and a second entity; and a processor unit that calculates, based on the information regarding the first derivatives transaction, one or more parameters for each of a second derivatives transaction and a third derivatives transaction; wherein the second derivatives transaction is between a clearing entity and the first entity, and the third derivatives transaction is between the clearing entity and the second entity; wherein the second derivatives transaction provides a substantially similar effect to the first entity as the first derivatives transaction; wherein the third derivatives transaction provides a substantially similar effect to the second entity as the first derivatives transaction; wherein the clearing entity is a limited recourse central counterparty, and wherein the processor unit comprises one or more processors.

### CROSS REFERENCE TO RELATED APPLICATIONS

This application claims priority to U.S. Provisional Patent Application No. 61/266,710, filed Dec. 4, 2009. The entire contents of that application are incorporated herein by reference.

### INTRODUCTION

“Netting” occurs when trading partners agree to offset their positions or obligations under two or more contracts on termination of those contracts. Netting is important because it reduces credit and liquidity risks, and ultimately systemic risk.

The effectiveness of netting as a tool to reduce credit risk is a function of the legal effectiveness of the netting provisions of the relevant contracts. A financial institution cannot prudently net its swap transactions with a counterparty or treat these exposures as collateralized unless it has obtained legal opinions confirming that netting is legally well founded in all relevant jurisdictions. As a result, the firm may be unable to apply netting to offsetting exposures or take collateral in jurisdictions where there is limited case law in relation to derivatives or structured finance, or where the legislative framework for financial products is not clearly defined.

As shown in FIGS. 1A and 1B, in jurisdictions where netting is not effective, transactions between a financial institution and a counterparty will result in a gross exposure to the financial institution. In the example shown in FIGS. 1A and 1B, Transaction 1 has a market value or “MTM” of 105 in favor of the counterparty, whereas Transaction 2 is valued at 100 in favor of the financial institution. The net MTM of these two trades is 5 in favor of the counterparty. As shown in FIG. 1B, in the case of default by the counterparty and in the absence of netting, the financial institution would be liable to pay the gross 105 MTM for Transaction 1 to the liquidator of the counterparty. The receipt of the 100 MTM return amount is uncertain and subject to the recovery rate following the default of the counterparty, leading to a potentially significant loss. Assuming a recovery rate of 40%, this implies a loss of 65 (i.e., pay 105, get 40 back).

Prior art Central Counterparties (or “CCPs”) have been structured on a full recourse basis.

Full Recourse CCPs

Prior art CCPs are structured on a full recourse basis. An original transaction between two parties who are members of the clearing house is replaced by equal and opposite transactions between the CCP and each of the clearing members. Since each of these transactions is on equal and opposite terms, the CCP does not have any market risk or economic risk on the transactions as long as each of the clearing members fulfills its contractual obligations. However, in the event of a default or insolvency of any clearing member, the CCP may be exposed to credit risk on the defaulting party. For this reason, CCPs seek a wide range of credit mitigants: initial margin, variation margin and limited member guarantees and default funds (see FIG. 9 for a simplified prior art CCP structure). In most circumstances, these mitigants are likely to be more than sufficient to cover the credit exposures of a CCP. Further, if the clearing members of the CCP are themselves limited to the most creditworthy financial institutions and the products cleared limited to the most liquid, standardized and well-understood products, the risk of CCP default might reasonably be considered not to be significant.

These factors explain the profile of CCP usage up until the financial crisis: very few defaults, but with individual CCPs organized around a limited geography, membership base, and product range. In addition, with the exception of the vanilla interest rate swaps cleared by the London Clearing House, almost no OTC derivative transactions were cleared. In comparison to the vanilla, standardized, fully collateralized world of CCPs, the OTC derivatives market presented a picture of considerable heterogeneity: many transactions were uncollateralized, and if collateralized, they were collateralized on widely varying terms, and the terms were applied with varying consistency. Each asset class also presented very different characteristics, interest rate derivatives were traded widely across both corporates and financial institutions, the use of credit derivatives was highly concentrated with financial institutions, and major commodity players played a significant trading role in commodity derivatives, while equity derivatives were significantly an end-user market, where relatively bespoke products were provided to institutions by banks. Documentation and processes differed widely. Some products were traded and administered in highly automated electronic environments; others relied on bespoke documentation and highly manual processes. Finally, the complexity and riskiness of products varied considerably, as did the success with which such risks had been successfully captured and managed by institutions or understood by regulators.

It is therefore no surprise that the G20 governments have proposed new laws focusing on greater transparency, standardization, and collateralization in the wake of the financial crisis, or that the CCP model has been seen as a reference point for how these objectives might be achieved. However, applying the full recourse CCP model to all or most OTC derivatives transactions presents significant difficulties:

1. Materially increasing the complexity, variety, and volume of cleared products will concentrate credit risk in relation to those products with the relevant CCPs, with the result that the failure of such a CCP could become a potential systemic event for the financial system.

2. These credit risks will be further concentrated if CCPs are opened up to a broader range of members, or connected to, or consolidated with, other CCPs.

3. A significant portion of the most complex and illiquid derivative transactions is likely to be unclearable by full recourse CCPs, if they are not to be themselves a source of systemic risk.

4. A significant number of less creditworthy financial institutions will not be eligible to join CCPs and share in the benefits of CCP membership (including multilateral netting).

### Overview of Certain Exemplary Embodiments

According to certain exemplary embodiments of at least one aspect, a clearing party is established as a bankruptcy remote company that will only enter into matching pairs of derivative transactions with a financial institution on the one hand and a counterparty on the other. The clearing party enters into transactions, either (i) directly with the counterparty, or (ii) following the transfer by novation of one or more existing derivative transaction(s) between the counterparty and the financial institution to the clearing party. The clearing party then enters into equal and opposite derivative transactions with the financial institution (i.e., a matching transaction). Each equal and opposite transaction is cross secured against obligations under its matching pair and also entered into on a limited recourse basis. The result of this process is that:
1. The counterparty has (or continues to have, if the trades are novated to the clearing party) an economic exposure to the financial institution identical to that it would have had if it had traded directly with the financial institution, because the obligations of the clearing party to the counterparty are secured by the obligations of the financial institution to the clearing party under the matching transaction.
2. The financial institution has (or continues to have, if existing trades are novated to the clearing party) an economic exposure to the counterparty identical to that it would have had if it had traded directly with the counterparty, because the obligations of the clearing party to the financial institution are secured by the obligations of the counterparty to the clearing party under the matching transaction.
3. Since the financial institution can establish the clearing party in a jurisdiction of its choice, it will be able to obtain clean legal opinions to the effect that the obligations of the clearing party to it under all matching transactions are net/collateralized.
4. Further, as the obligations of the clearing house to the counterparty under its transactions with the counterparty are limited to the rights the clearing party has under the matching transactions with the financial institution, the financial institution is also in principle able to obtain legal opinions to the effect that the counterparty can never claim more than the net amount due under the matching transactions.
5. As a result of 3 and 4, the financial institution is now able to treat its exposure as effectively net.

Various exemplary embodiments of certain aspects (including system, software, and method embodiments) provide benefits to both a counterparty and a financial institution. The counterparty benefits from executing trades via the clearing party, either by receiving better pricing from the financial institution or by being able to enter into transactions with the financial institution of a greater tenor or size. The financial institution benefits by being able to either release reserves or regulatory capital for existing trades that are novated by the counterparty to the clearing party, or by being able to make more profit from new business. Further, as the clearing party structure is cost effective and scalable, it provides financial institutions with a potential competitive business advantage in each jurisdiction in which netting is not effective.

FIG. 2 is a simplified transaction flow chart showing the booking of derivatives transactions according to an exemplary embodiment. In step S002, a trade is initially executed between two counterparties. For ease of illustration, in this example the two counterparties are identified as Financial Institution 10 and Corporation 12. However, it should be appreciated that the initial trade may be executed between any type of entity. In step S004, Financial Institution 10 novates its positions to Clearing House 14, resulting in Financial Institution 10 “stepping out” of its exchange with Corporation 12. The result of step S004 is that Corporation 12 now faces Clearing House 14 in place of Corporation 12. If there are no existing transactions with the counterparty which the financial institution wishes to net, then the transactions may be entered into directly with the clearing party, and step S004 will not be needed. Concurrently, with step S006, financial institution 10 enters into an economically identical swap with Clearing House 14. Each of these trades is cross secured on a limited recourse basis against the other.

In another aspect, embodiments comprise a limited recourse CCP structure and related systems, software, and methods, as described below.

Another aspect comprises a computer system comprising: (a) a computer readable memory that stores information regarding a first derivatives transaction between a first entity and a second entity; and (b) a processor unit that is in communication with the computer readable memory and that calculates, based on the information regarding the first derivatives transaction, one or more parameters for each of a second derivatives transaction and a third derivatives transaction; wherein the second derivatives transaction is between a clearing entity and the first entity, and the third derivatives transaction is between the clearing entity and the second entity; wherein the second derivatives transaction provides a substantially similar effect to the first entity as the first derivatives transaction; wherein the third derivatives transaction provides a substantially similar effect to the second entity as the first derivatives transaction; wherein the first entity's rights against the clearing entity under the second derivatives transaction are limited by the clearing entity's rights against the second entity under the third transaction; wherein the second entity's rights against the clearing entity under the third derivatives transaction are limited by the clearing entity's rights against the first entity under the second derivatives transaction, and wherein the processor unit comprises one or more processors.

In various exemplary embodiments: (1) the one or more parameters comprise credit exposure data for the second derivatives transaction and for the third derivatives transaction; (2) the one or more parameters comprise reserve capital data for the second derivatives transaction and for the third derivatives transaction; and (3) the one or more parameters comprise profit level data for the second derivatives transaction and for the third derivatives transaction.

Another aspect comprises a computer system comprising: (a) a computer readable memory that stores information regarding a first derivatives transaction between a first entity and a second entity; and (b) a processor unit that is in communication with the computer readable memory and that calculates, based on the information regarding the first derivatives transaction, one or more parameters for each of a second derivatives transaction and a third derivatives transaction; wherein the second derivatives transaction is between a clearing entity and the first entity, and the third derivatives transaction is between the clearing entity and the second entity; wherein the second derivatives transaction provides a substantially similar effect to the first entity as the first derivatives transaction; wherein the third derivatives transaction provides a substantially similar effect to the second entity as the first derivatives transaction; wherein the clearing entity is a limited recourse central counterparty, and wherein the processor unit comprises one or more processors.

In various exemplary embodiments: (1) the one or more parameters comprise credit exposure data for the second derivatives transaction and for the third derivatives transaction; (2) the one or more parameters comprise reserve capital data for the second derivatives transaction and for the third derivatives transaction; and (3) the one or more parameters comprise profit level data for the second derivatives transaction and for the third derivatives transaction.

Each of the above aspects and embodiments has one or more corresponding software and method embodiments, as will be seen below.

### BRIEF DESCRIPTION OF THE DRAWINGS

FIGS. 1A and 1B illustrate credit exposures under two derivatives transactions between two counterparties pre and post default according to the prior art.

FIG. 2 is a simplified transaction flow chart showing a method for clearing of derivatives transactions according to an exemplary embodiment.

FIGS. 3A-C is a flow chart showing the execution process of a trade using the clearing party according to an exemplary embodiment from the point of view of a financial institution entering into a trade with a potential client.

FIGS. 4A and 4B illustrate derivatives transactions between a defaulting counterparty and a financial institution in a non-netting jurisdiction according to an exemplary embodiment.

FIGS. 5A and 5B illustrate derivatives transactions between a counterparty and a defaulting financial institution according to an exemplary embodiment.

FIG. 6 illustrates credit contingent derivatives transactions between two counterparties according to an exemplary embodiment.

FIG. 7 illustrates derivatives transactions between two counterparties and a financial institution and illustrates how the counterparties can expand the benefits of netting in the event of the default of the financial institution according to an exemplary embodiment.

FIG. 8 illustrates derivatives transactions between two members of a counterparty group of companies and illustrates how a financial institution can effectively net exposures between both members of the counterparty group in their default according to an exemplary embodiment.

FIG. 9 depicts a prior art full recourse CCP structure.

FIG. 10 depicts a limited recourse CCP structure according to an exemplary embodiment.

FIG. 11 depicts exemplary limited recourse CCP netting and clearing.

FIG. 12 depicts exemplary allocation of residual losses (due to incorrect valuation or mis-margining) among non-defaulting clearing members following the default of a member of an exemplary limited recourse CCP.

FIG. 13 depicts exemplary operating processes for a limited recourse CCP.

FIG. 14 depicts an exemplary computer implementation.

### DETAILED DESCRIPTION OF CERTAIN EXEMPLARY EMBODIMENTS

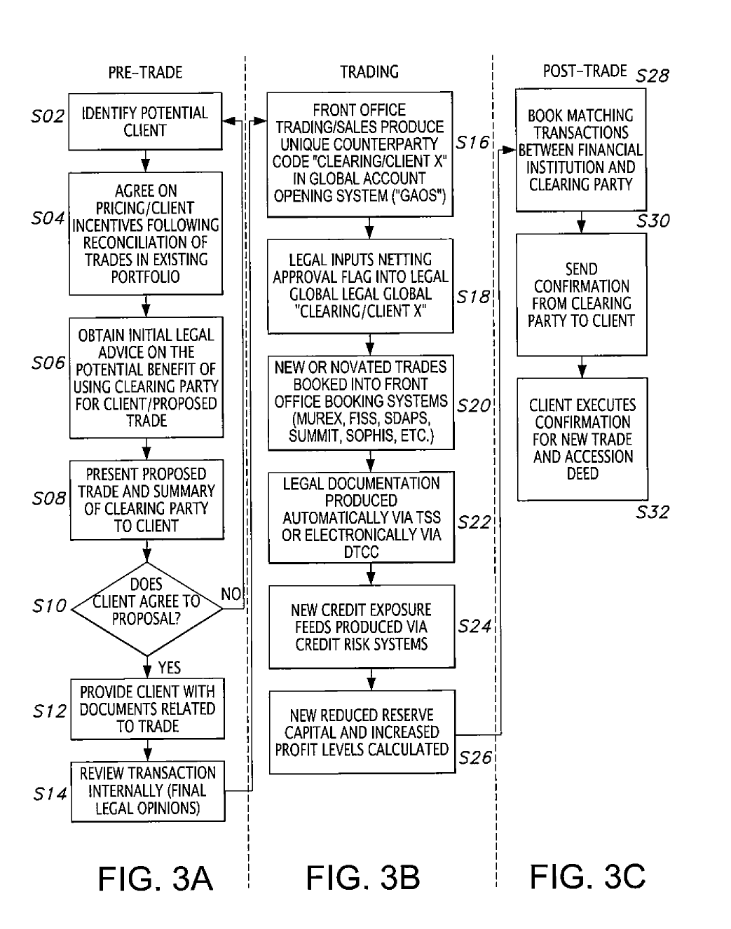

FIGS. 3A, 3B and 3C are flow charts showing the execution process of a trade using the clearing party according to at least one exemplary embodiment from the point of view of a financial institution entering into a trade with a potential client.

Steps S02-S14 of the execution process occur pre-trade, steps S16-26 are the trading process, and steps S28-32 are the post trade execution processes. In step S02 of the process, the financial institution identifies a potential client based, for example, on benefit of netting/collateralizing the current portfolio and profitability of a new trade with netting/collateral, or on a credit contingent basis. In step S04 of the process, the financial institution agrees on pricing and/or client incentives following proposed reconciliation of the trades in the existing portfolio.

In step S06 of the process, the financial institution obtains initial external legal advice on the potential benefit of using the clearing party for the client/proposed trade. In step S08, the financial institution presents the proposed trade and a summary of the role of the clearing party to the client. In step S10, it is determined whether the client agrees to the proposed trade. If so, the process continues to step S12, where the client is presented with documents related to the proposed trade, including a clearing party information memorandum setting out details of the relevant documentation (and which may be considered the equivalent to a prospectus for shares or notes), and an accession deed creating the limited recourse secured contracts between the clearing party, the financial institution and the client (as counterparty). In step S14, final legal opinions are obtained in order to determine whether to go forward with the overall transaction.

In steps S16-28 the trading process takes place between the clearing party and the financial institution. In step S16, a new client entity “counterparty/client X” is established in the financial institution's computer systems. In step S18, the legal department inputs approvals to net/collateralize exposure against counterparty/client X in a database, such as, for example, a global legal approval database. In step S20, details of the new or novated trades are entered into electronic booking and trading systems, such as, for example, MUREX, FISS, SDAPS, SOPHIS, SUMMIT, etc. In step S22, legal documentation is electronically produced using, for example, TTS or DTCC. In step S24, new credit exposure feeds are produced using the data from the legal approval database and the trade booking systems. In step S26, reduced credit reserves and capital are electronically calculated in a derivative counterparty credit risk computer system and increased profit is immediately recognized via electronic finance systems.

In step S28, which takes place post-trade, trade confirmations are electronically produced for the matching trade between the counterparty and the clearing party. In step S30, confirmation of the trade is sent to the client from the clearing party, either directly or by the financial institution as agent. In step S32, the client, the financial institution and the clearing party execute the trade confirmation documents and the accession deed.

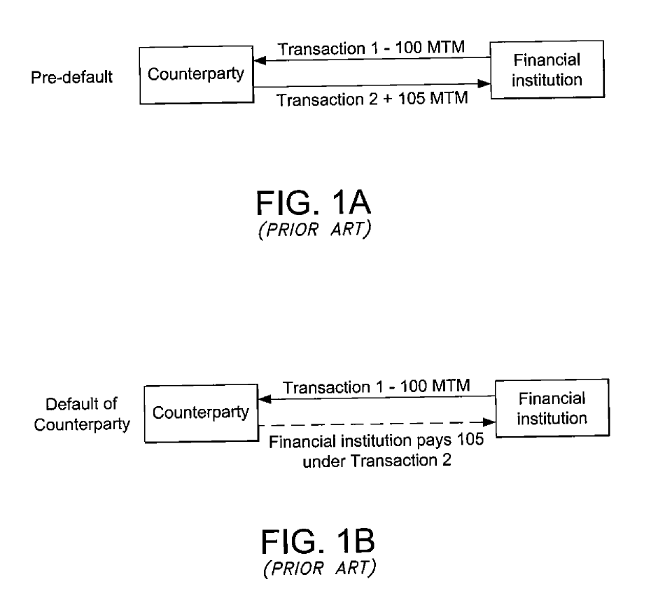

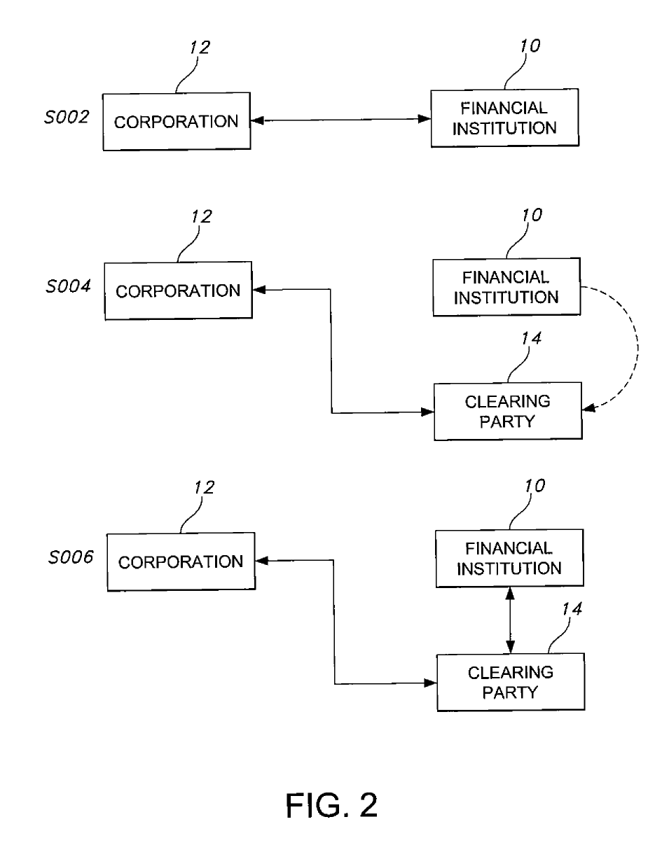

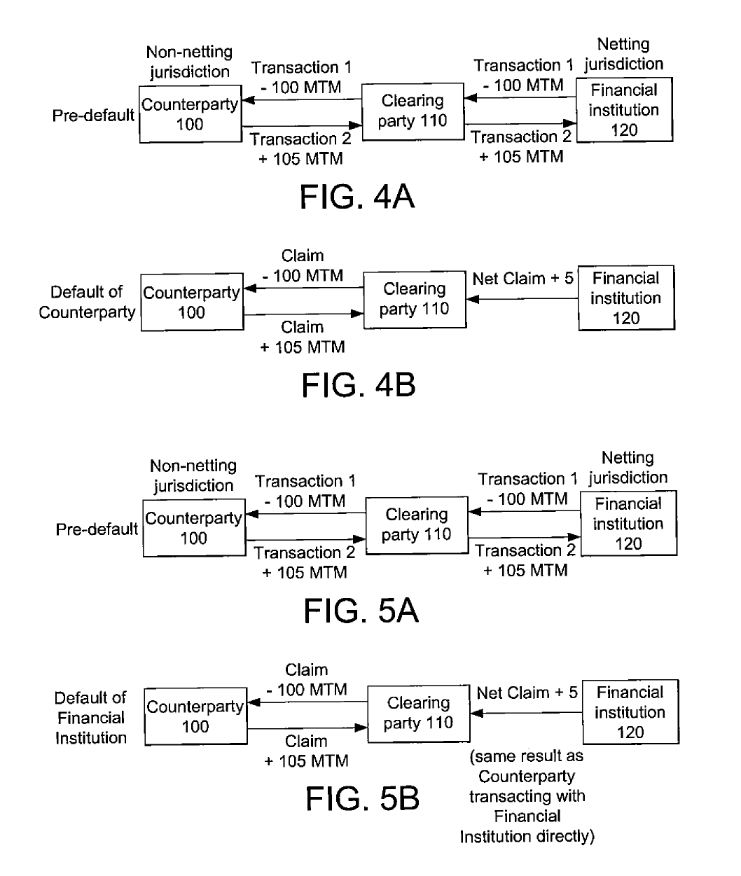

FIGS. 4A and 4B illustrate an exemplary method for netting derivative transactions according to an exemplary embodiment following execution of the transactions in accordance with the above process. Where a counterparty 100 novates its transactions to a clearing party 110 and simultaneously enters into equal and offsetting transactions with financial institution 120, then in the case of default of the counterparty 100, all transactions are closed out and as illustrated in FIG. 4B, the clearing party 110 has a net claim for 5 against the financial institution. In the event that the counterparty's liquidators seek to claim the gross amount as per FIGS. 1A and 1B, then the clearing party can limit its payment of such claim to the net claim for 5, in reliance upon the limited recourse security arrangements entered into between it and the counterparty.

Further, as illustrated by the example shown in FIGS. 5A and 5B, where a counterparty 100 novates its transactions to a clearing party 110 and simultaneously enters into equal and offsetting transactions with financial institution 120, it continues to have the recourse on a net basis to the financial institution in the financial institution's default that it would have had if it entered into the transactions with the financial institution directly, since both sets of transactions are secured against each other on a limited recourse basis. As shown in FIG. 5B, in the case of default by the financial institution 120, all transactions are closed out and the counterparty 120 claims +5 via the clearing party 110 as per the security provisions. Since netting is applicable in the financial institution 120's jurisdiction, the clearing party 110 claims 5 net from the financial institution 120. Accordingly, the counterparty 100 has the same exposure as if it faced the financial institution 120 directly.

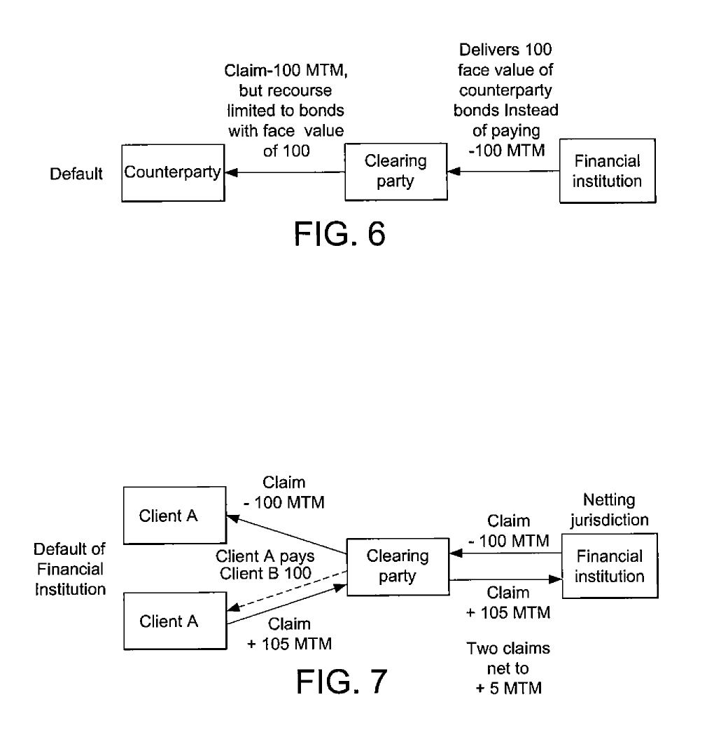

One key constraint to trading credit contingent or extinguisher swaps is the absence of clean legal opinions in many jurisdictions. As with netting and collateral, booking such trades on a limited recourse secured basis via the clearing party according to one or more embodiments improves the legal analysis and may enable the financial institution to execute these transactions in a broader range of jurisdictions. A key difference from the standard swaps booked via the clearing party is that the financial institution has the right to settle certain specified transactions by the delivery of bonds or loans with a face value equal to the market value of the transactions otherwise owed to the clearing party. These bonds or loans may be of the counterparty, its affiliates, or of a third party (this is illustrated in the example shown in FIG. 6). In consideration of the agreement to receive an asset which may have a market value less than its face value at the time of delivery, the client benefits either from better pricing or by being able to execute in greater size or for longer tenor.

Clients who use the clearing party can still net against the financial institution in the case of its default. However, it is also possible for clients of the clearing party to improve their netting position in the default of the financial institution. In this regard, as illustrated in the example shown in FIG. 7, if two clients have elected to permit the clearing party to apply an expanded set off provision to the terms of the clearing party's matching contracts with the financial institution, then in addition to following usual close out procedures, the amounts due to and from the clearing party to the financial institution in respect of the matching transactions with the two counterparties may also be set off. In FIG. 7, since the clearing party is able to net the 105 it is owed by the defaulting financial institution in respect of the matching transaction with counterparty B against the 100 due to the defaulting financial institution in respect of the matching transaction with counterparty A, the clearing party is able to pay the 100 received from Client A to Client B (instead of paying it to the liquidator of the financial institution), and Client B (via the clearing party) may claim the remaining 5 from the financial institution's liquidators.

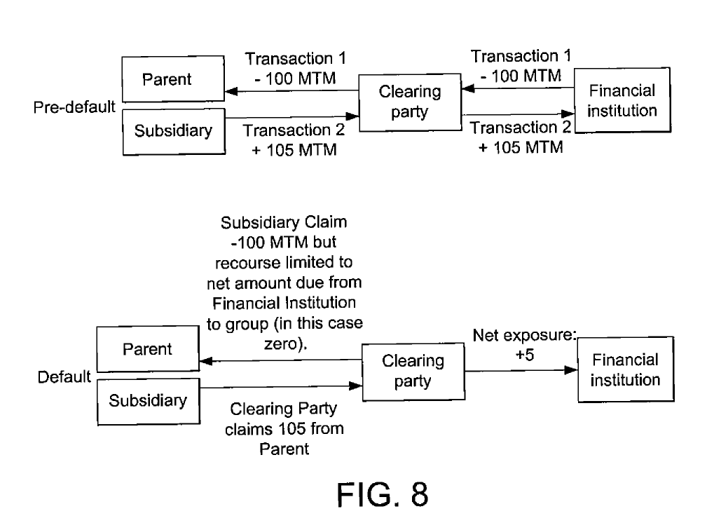

As explained above, multiple clients (including groups of clients) can use the clearing party to improve netting if the financial institution defaults. However, it is also possible for the financial institution to use the limited recourse provisions to effectively net across a client group. This is illustrated by the example shown in FIG. 8, in which two companies (Parent and Subsidiary) in the counterparty group have entered into matching transactions with the financial institution via the clearing party, and on default of both Parent and Subsidiary, the clearing party owes Subsidiary 100, and Parent owes the clearing party 105, with the recovery on Subsidiary debt being 40%. The net amount due to the financial institution by the clearing party is +5 MTM. Again the limited recourse security provisions are used, since netting across insolvent companies is not legally certain in insolvency in many jurisdictions. In this case, the recourse of Parent against the clearing party is limited to the sum of the net amount due to the clearing party by the financial institution (in this case zero) and any “excess” recoveries received on the claim for 105 made by the clearing party against the liquidators of Parent against the clearing party, and “excess” is defined to be an amount such that the financial institution receives recoveries on a net amount of 5 (which it would receive if Parent and Subsidiary were one legal entity). The clearing party is therefore able to pay Subsidiary not more than 40%×(105−5), or 40.

In another aspect, the invention comprises methods and systems regarding limited recourse central counterparties for OTC derivatives. Those skilled in the art will realize that statements made herein (for example, in relation to limited recourse central counterparties) are intended to be exemplary only, are non-limiting, and apply generally to other embodiments as well.

A limited recourse CCP, as described herein, may be used to clear OTC derivatives transactions, subject to minimum operational requirements, and is consistent with the framework and goals of the Dodd-Frank legislation and other G20 clearing laws and regulations.

Limited Recourse CCPs

Under US (and English) law, limited recourse financing involves an acknowledgment in the terms of the relevant contract or security by a party that its rights in relation to defined assets are limited to claims under a security interest or trust granted by its counterparty, coupled with a promise by the same party that it will not seek to make any claim in any court to the contrary, including making any winding up petition.

In an embodiment, the application of limited recourse principles to a CCP for OTC derivatives transactions may comprise the following steps:

1. The original OTC derivative transaction between two clearing members of a CCP is replaced by equal and opposite transactions between the CCP and the two clearing members.

2. Each of these transactions is secured against the other on a limited recourse basis, with the effect that in the event of the default of one member, the rights of the other member against the CCP are limited to the CCPs rights under its contract with the defaulting member, and neither member would have any right to wind up the CCP.

3. As each of these security interests is granted by the CCP under English law security agreements in relation to English law governed contracts, the effectiveness of these arrangements should not be impacted by the laws of any other jurisdiction.

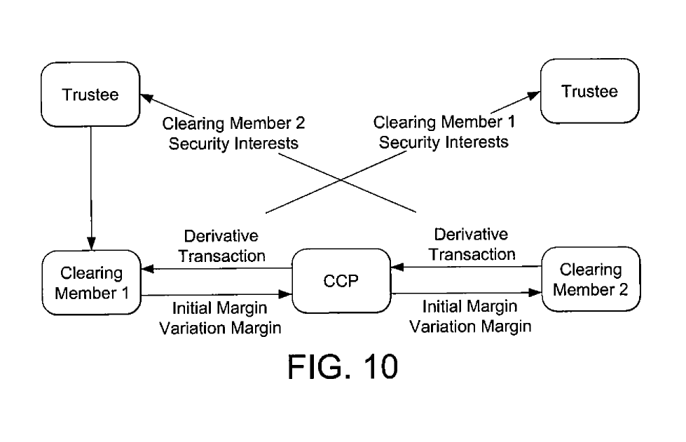

3. Each clearing member continues to collateralize its obligations to the CCP as before (see FIG. 10 for an exemplary simplified structure diagram).

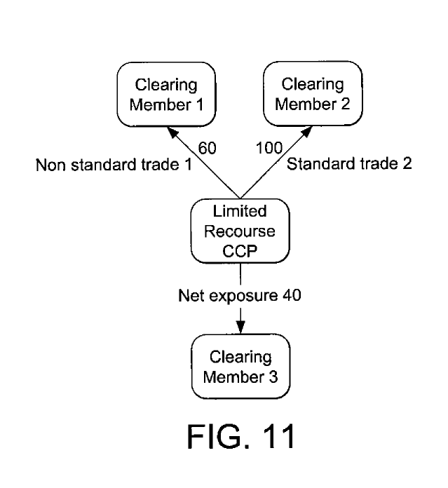

The CCP thus becomes a bankruptcy remote entity that structurally avoids any credit risk on its business. While it continues to act as a central counterparty on all contracts and to hold collateral for its members, it cannot default even if all of its members default. Further, it is still able to achieve all of the key benefits of a standard full recourse clearing house: (1) collateralization; (2) high quality collateral management and transaction reporting, and (3) multilateral netting (see FIG. 11) (subject to the usual legal analysis performed by full recourse CCPs on the effectiveness of netting and margining provisions in the insolvency of a clearing member).

In addition to removing any credit risk from the CCP itself, a limited recourse CCP structure also changes the credit risk profile of its members. In a full recourse clearing structure, one of the credit mitigants employed by the CCP, in addition to initial and variation margin, is to call for limited guarantees or default funds from clearing members. The purpose of these guarantees and default funds, is that if in the event initial and variation margin are insufficient in the default of a clearing member, the CCP can “mutualize” remaining losses. This has two limitations: first, for the member being “mutualized,” this represents a real financial loss that may be completed unrelated to its business with the defaulting clearing member; and second, in the event that such guarantees are insufficient, the CCP itself may default.

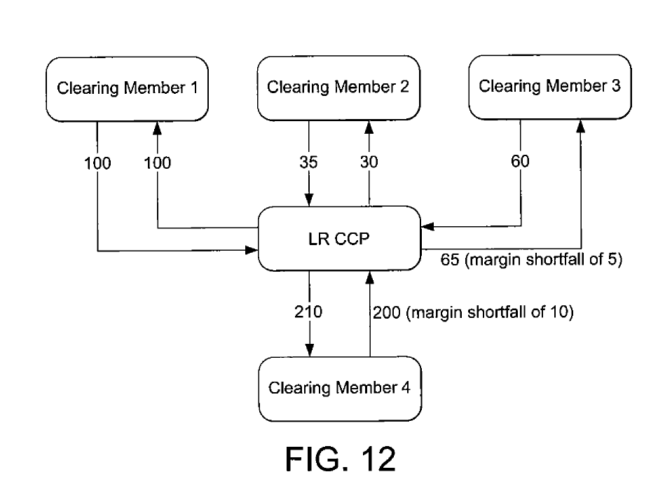

By contrast, in the case of a limited recourse CCP, not only will the CCP not default, but any residual losses following the application of initial and variation margin (and after multilateral netting) can be apportioned to each clearing member pro rata on the basis of its original OTC derivative exposure (see FIG. 12 for examples in relation to incorrect valuations or mis-margining).

This has a number of very important implications in relation to both the scale and scope of CCPs:

1. The most complex and illiquid derivative transactions may be cleared by limited recourse CCPs, without increasing systemic risk or posing additional risks or liabilities on the original parties to these cleared transactions.

2. A limited recourse CCP may be opened up to the broadest possible range of members, who will thereby share in the benefits of CCP membership (including multilateral netting) without being subject to risk or liabilities in respect of either the clearing house or any clearing member with whom they have not entered into cleared transactions.

3. Derivative transactions of all asset classes may be cleared by a single limited recourse CCP, and transactions that currently are cleared by a single asset class CCP may be migrated to a limited recourse CCP without increasing legal or systemic risk, while at the same time increasing the benefits of multilateral netting.

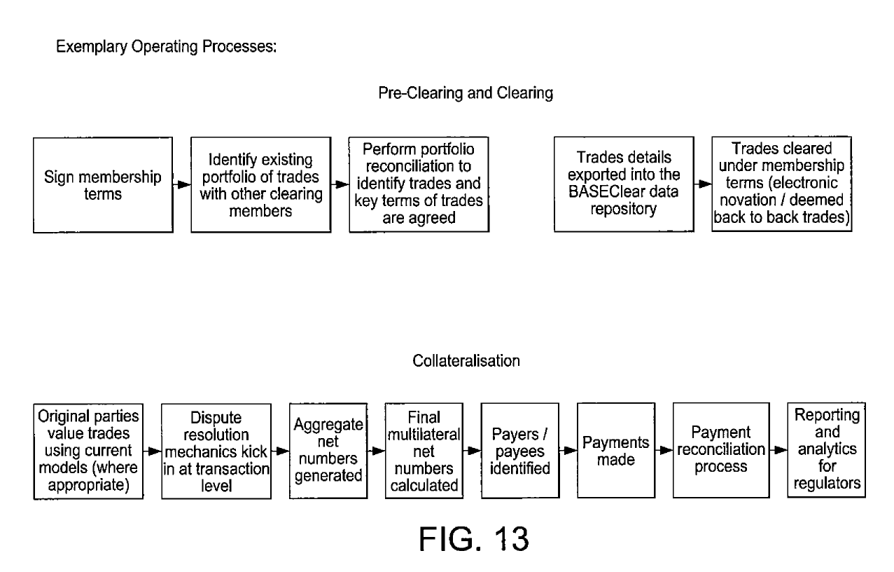

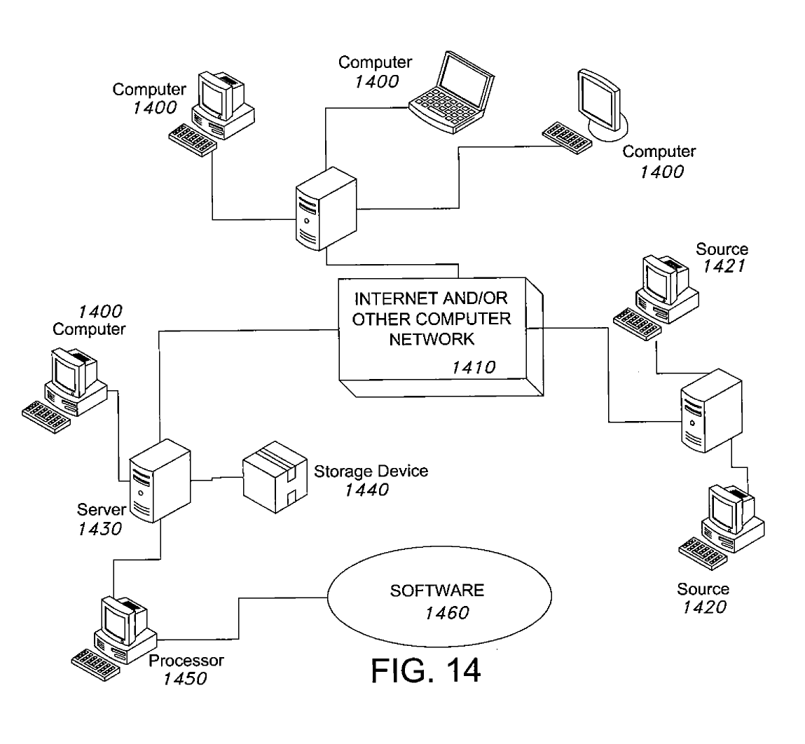

4. The business of a limited recourse CCP is therefore cost-effective and scalable across the global derivatives markets. See FIG. 13 for a description of exemplary operational processes for an exemplary limited recourse CCP to clear complex or illiquid OTC derivatives.

5. A limited recourse CCP is therefore not only consistent with the objectives of clearing regulations, but is arguably necessary for them to be fully achieved. A full recourse CCP cannot clear complex or illiquid trades without increasing systemic risk, but the effectiveness of US and G20 clearing regulations would be materially limited if these complex or illiquid trades, which should be of greatest concern to regulators, are left outside the scope of clearing.

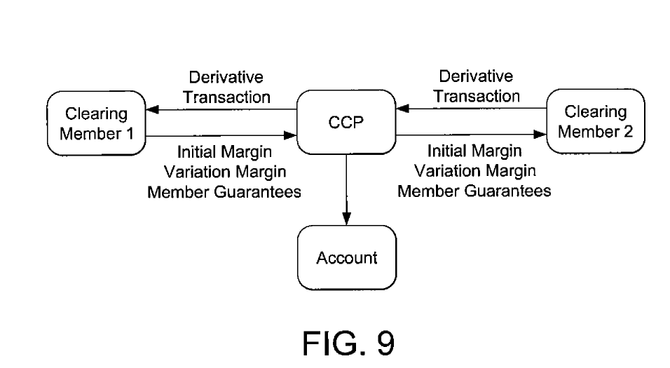

Annex 1—Full Recourse CCP Structure (see FIG. 9).

Annex 2—Limited Recourse CCP Structure (see FIG. 10).

Annex 3—Limited Recourse CCP Netting (see FIG. 11). CCPs potentially increase netting benefits. However, moving some but not all OTC trades to a CCP or the emergence of a highly fragmented CCP market may actually reduce netting for the relevant clearing member. A limited recourse structure enables CCPs to prudently clear more business/merge with other CCPs, but still enables non standard trade 1 to be set off against non standard trade 2.

Annex 4—Limited Recourse CCP: Misvaluation or Mismargining (see FIG. 12).
Clearing Member 3 has entered into non-standard trades with Clearing Member 4. Close out value is 65 but due to misvaluation there is a margin shortfall of 5.
Clearing Member 2 has only entered into standard trades but shortfall in margin due to intraday price spike of 5 Close out value of 35 and margin shortfall of 5.
Clearing Member 1 has entered into trades with Clearing Member 4 with exposure of 100 and with margin of 100.
With Limited Recourse CCP, Clearing Member 3 loses 5, Clearing Member 2 loses 5 and Clearing Member 1 loses 0.
Without Limited Recourse CCP, losses are mutualized 3.33 equally.

Annex 5: Exemplary Limited Recourse CCP Operational Processes (see FIG. 13).

Exemplary Limited Recourse CCP Operational structure may reflect and continuously improve on best market practices, such as 2010 ISDA “Best Practices for the OTC Derivatives Collateral Process.”

Sign up and Pre-clearing: (a) may require all collateral terms and messaging to be standardized via membership terms; (b) legal collateral, capacity, and netting feeds fully integrated into membership agreements; (c) use of best of breed portfolio reconciliation (Tri-resolve) and data extraction techniques; and (d) ongoing targets to reduce time between trading and clearing.

Post-clearing: (a) clearing members to manage collateral calls and disputes bilaterally in first instance and agree to use market data points and other valuation techniques where available; (b) CCP intervenes as dispute management/valuation agent; (c) all swap payments continue to be made between original transaction parties; (d) two way initial margin (if any) is segregated with third party custodian and one variation margin payments made in cash on a multilateral net basis derived from bilateral calls; and (e) clearing house can satisfy CCP reporting requirements to regulators and to clearing members, but may also provide them with better tools for identification of concentration risk and modeling inconsistencies (e.g., using the current Totem process for actual trades).

Embodiments comprise computer components and computer-implemented steps that will be apparent to those skilled in the art. For example, calculations and communications can be performed electronically, and agreements can be composed, transmitted, and executed electronically. An exemplary system is depicted in FIG. 16. As shown, computers 1600 communicate via network 1610 with a central server 1630. A plurality of sources of data 1620-1621 relating to, for example, derivatives and related transactions, also communicate via network 1610 with a central server 1630, processor 1650, and/or other components to calculate and transmit CPP, account, and related information. The server 1630 may be coupled to one or more storage devices 1640, one or more processors 1650, and software 1660.

Other components and combinations of components may also be used to support processing data or other calculations described herein as will be evident to one of skill in the art. Server 1630 may facilitate communication of data from a storage device 1640 to and from processor(s) 1650, and communications to computers 1600. Processor 1650 may optionally include local or networked storage (not shown) which may be used to store temporary information. Software 1660 can be installed locally at a computer 1600, processor 1650 and/or centrally supported for facilitating calculations and applications.

For ease of exposition, not every step or element is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the invention.

For example, computerized steps for netting embodiments and aspects will generally apply as well to limited recourse CCP embodiments and aspects. That is, a financial institution will generally book, calculate, and monitor its net, collateralized exposures to its OTC counterparty both before and after clearing using the systems and methods described herein.

CCPs are almost entirely computerized (in order to clear, margin, and report on transactions). A limited recourse CCP according to one or more of the embodiments described herein generally operates in an automated and computerized fashion. Also, a limited recourse CCP may call for margin in a highly automated fashion, and be integrated into transaction valuation systems of one or more clearing members.

Further, in order for a limited recourse CCP to meet its reporting and risk management requirements in relation to a very large and diverse membership, membership agreements may be concluded and amended in electronic form and integrated with legal opinion databases in relation to legal capacity, netting, and collateralization.

Moreover, where a computer system is described or claimed as having a processor for performing a particular function, it will be understood by those skilled in the art that such usage should not be interpreted to exclude systems where a single processor, for example, performs some or all of the tasks delegated to the various processors. That is, any combination of or all of, the processors specified in the claims could be the same processor. All such combinations are within the scope of the invention.

Alternatively, or in combination, processing and decision-making may be performed by functionally equivalent circuits such as a digital signal processor circuit or an application specific integrated circuit (ASIC). Many routine program elements, such as initialization of loops and variables and the use of temporary variables, are not shown. It will be appreciated by those of ordinary skill in the art that unless otherwise indicated herein, the particular sequence of steps described is illustrative only and can be varied without departing from the spirit of the invention. Thus, unless otherwise stated, the processes described herein are unordered—that is, the processes can be performed in any reasonable order.

All steps described herein will be understood by those skilled in the art as being capable of implementation by software, where feasible. Moreover, such software will be understood by those skilled in the art to be storable on a non-transitory computer readable medium and implementable by one or more computer processors.

While this invention has been described in conjunction with certain exemplary embodiments, many alternatives, modifications and variations encompassed by the invention will be apparent to those skilled in the art. Accordingly, the exemplary aspects and embodiments of the invention set forth above are intended to be illustrative, and not limiting. Various changes may be made without departing from the spirit and scope of the invention.

We claim:

1. A computer system comprising:
a computer readable memory that stores information regarding a first derivatives transaction between a first entity and a second entity; and
a processor unit that is in communication with said computer readable memory and that calculates, based on said information regarding said first derivatives transaction, one or more parameters for each of a second derivatives transaction and a third derivatives transaction;
wherein said second derivatives transaction is between a clearing entity and said first entity, and said third derivatives transaction is between said clearing entity and said second entity;
wherein said second derivatives transaction provides a substantially similar effect to said first entity as said first derivatives transaction;
wherein said third derivatives transaction provides a substantially similar effect to said second entity as said first derivatives transaction;
wherein said first entity's rights against said clearing entity under said second derivatives transaction are limited by said clearing entity's rights against said second entity under said third transaction;
wherein said second entity's rights against said clearing entity under said third derivatives transaction are limited by said clearing entity's rights against said first entity under said second derivatives transaction, and
wherein said processor unit comprises one or more processors.

2. A computer system as in claim 1, wherein said one or more parameters comprise credit exposure data for said second derivatives transaction and for said third derivatives transaction.

3. A computer system as in claim 1, wherein said one or more parameters comprise reserve capital data for said second derivatives transaction and for said third derivatives transaction.

4. A computer system as in claim 1, wherein said one or more parameters comprise profit level data for said second derivatives transaction and for said third derivatives transaction.

5. A computer system comprising:
a computer readable memory that stores information regarding a first derivatives transaction between a first entity and a second entity; and
a processor unit that is in communication with said computer readable memory and that calculates, based on said information regarding said first derivatives transaction, one or more parameters for each of a second derivatives transaction and a third derivatives transaction;
wherein said second derivatives transaction is between a clearing entity and said first entity, and said third derivatives transaction is between said clearing entity and said second entity;
wherein said second derivatives transaction provides a substantially similar effect to said first entity as said first derivatives transaction;
wherein said third derivatives transaction provides a substantially similar effect to said second entity as said first derivatives transaction;
wherein said clearing entity is a limited recourse central counterparty, and
wherein said processor unit comprises one or more processors.

6. A computer system as in claim 5, wherein said one or more parameters comprise credit exposure data for said second derivatives transaction and for said third derivatives transaction.

7. A computer system as in claim 5, wherein said one or more parameters comprise reserve capital data for said second derivatives transaction and for said third derivatives transaction.

8. A computer system as in claim 5, wherein said one or more parameters comprise profit level data for said second derivatives transaction and for said third derivatives transaction.

9. An article of manufacture storing software in a non-transitory computer readable medium, said software configured to direct one or more processors to perform the following steps:
storing in a computer readable memory information regarding a first derivatives transaction between a first entity and a second entity; and
calculating, based on said information regarding said first derivatives transaction, one or more parameters for each of a second derivatives transaction and a third derivatives transaction;
wherein said second derivatives transaction is between a clearing entity and said first entity, and said third derivatives transaction is between said clearing entity and said second entity;
wherein said second derivatives transaction provides a substantially similar effect to said first entity as said first derivatives transaction;
wherein said third derivatives transaction provides a substantially similar effect to said second entity as said first derivatives transaction;
wherein said first entity's rights against said clearing entity under said second derivatives transaction are limited by said clearing entity's rights against said second entity under said third transaction; and
wherein said second entity's rights against said clearing entity under said third derivatives transaction are limited by said clearing entity's rights against said first entity under said second derivatives transaction.

10. An article of manufacture as in claim 9, wherein said one or more parameters comprise credit exposure data for said second derivatives transaction and for said third derivatives transaction.

11. An article of manufacture as in claim 9, wherein said one or more parameters comprise reserve capital data for said second derivatives transaction and for said third derivatives transaction.

12. An article of manufacture as in claim 9, wherein said one or more parameters comprise profit level data for said second derivatives transaction and for said third derivatives transaction.

13. An article of manufacture storing software in a non-transitory computer readable medium, said software configured to direct one or more processors to perform the following steps:
storing in a computer readable memory information regarding a first derivatives transaction between a first entity and a second entity; and
calculating, based on said information regarding said first derivatives transaction, one or more parameters for each of a second derivatives transaction and a third derivatives transaction;
wherein said second derivatives transaction is between a clearing entity and said first entity, and said third derivatives transaction is between said clearing entity and said second entity;
wherein said second derivatives transaction provides a substantially similar effect to said first entity as said first derivatives transaction;
wherein said third derivatives transaction provides a substantially similar effect to said second entity as said first derivatives transaction; and
wherein said clearing entity is a limited recourse central counterparty.

14. An article of manufacture as in claim 13, wherein said one or more parameters comprise credit exposure data for said second derivatives transaction and for said third derivatives transaction.

15. An article of manufacture as in claim 13, wherein said one or more parameters comprise reserve capital data for said second derivatives transaction and for said third derivatives transaction.

16. An article of manufacture as in claim 13, wherein said one or more parameters comprise profit level data for said second derivatives transaction and for said third derivatives transaction.

17. A method comprising the following steps:
storing in a computer readable memory information regarding a first derivatives transaction between a first entity and a second entity; and
calculating, with a processor unit, based on said information regarding said first derivatives transaction, one or more parameters for each of a second derivatives transaction and a third derivatives transaction;
wherein said second derivatives transaction is between a clearing entity and said first entity, and said third derivatives transaction is between said clearing entity and said second entity;
wherein said second derivatives transaction provides a substantially similar effect to said first entity as said first derivatives transaction;
wherein said third derivatives transaction provides a substantially similar effect to said second entity as said first derivatives transaction;
wherein said first entity's rights against said clearing entity under said second derivatives transaction are limited by said clearing entity's rights against said second entity under said third transaction;
wherein said second entity's rights against said clearing entity under said third derivatives transaction are limited by said clearing entity's rights against said first entity under said second derivatives transaction, and
wherein said processor unit comprises one or more processors.

18. A method as in claim 17, wherein said one or more parameters comprise credit exposure data for said second derivatives transaction and for said third derivatives transaction.

19. A method as in claim 17, wherein said one or more parameters comprise reserve capital data for said second derivatives transaction and for said third derivatives transaction.

20. A method as in claim 17, wherein said one or more parameters comprise profit level data for said second derivatives transaction and for said third derivatives transaction.

21. A method comprising the following steps:
storing in a computer readable memory information regarding a first derivatives transaction between a first entity and a second entity; and
calculating, with a processor unit, based on said information regarding said first derivatives transaction, one or more parameters for each of a second derivatives transaction and a third derivatives transaction;
wherein said second derivatives transaction is between a clearing entity and said first entity, and said third derivatives transaction is between said clearing entity and said second entity;
wherein said second derivatives transaction provides a substantially similar effect to said first entity as said first derivatives transaction;
wherein said third derivatives transaction provides a substantially similar effect to said second entity as said first derivatives transaction;
wherein said clearing entity is a limited recourse central counterparty, and
wherein said processor unit comprises one or more processors.

22. A method as in claim 13, wherein said one or more parameters comprise credit exposure data for said second derivatives transaction and for said third derivatives transaction.

23. A method as in claim 13, wherein said one or more parameters comprise reserve capital data for said second derivatives transaction and for said third derivatives transaction.

24. A method as in claim 13, wherein said one or more parameters comprise profit level data for said second derivatives transaction and for said third derivatives transaction.
